(19) United States
(12) Patent Application Publication
(10) Pub. No.: US 2024/0221369 A1
(43) Pub. Date: Jul. 4, 2024

(54) METHOD AND SYSTEM FOR ACTIVE LEARNING USING ADAPTIVE WEIGHTED UNCERTAINTY SAMPLING(AWUS)

(71) Applicants: Mihaela VLASEA, Kitchener (CA); Gijs Johannesan Jozef VAN HOUTUM, Waterloo (CA)

(72) Inventors: Mihaela VLASEA, Kitchener (CA); Gijs Johannesan Jozef VAN HOUTUM, Waterloo (CA)

(21) Appl. No.: 18/569,625

(22) PCT Filed: Jun. 15, 2022
(86) PCT No.: PCT/CA2022/050956

§ 371 Date: Dec. 13, 2023

Related U.S. Application Data
(60) Provisional application No. 63/211,214, filed on Jun. 16, 2021.

(51) Int. Cl. G06V 10/774; G06V 10/771; G06V 20/70

(52) U.S. Cl. CPC G06V 10/7753; G06V 10/771; G06V 20/70

(57) ABSTRACT

A method and system of active learning that includes receiving a set of data instances, passing the set of data instances through an adaptive weighted uncertainty sampling methodology to select a set of unlabeled data instances and the determining if any of the set of unlabeled data instances need to be further processed. The AWUS methodology assigns a weighting to each of the selected unlabeled data instances whereby the weighting may be used to determine which of the set of unlabeled data instances should be further processed.

### CROSS-REFERENCE TO OTHER APPLICATIONS

The current application claims priority from U.S. Provisional Application No. 63/211,214 filed Jun. 16, 2021, which is hereby incorporated by reference.

### FIELD

The current disclosure is generally directed at active learning, and, more specifically, at a method and system for active learning using adaptive weighted uncertainty sampling (AWUS).

### BACKGROUND

Machine learning (ML) has been applied to many areas of the additive manufacturing (AM) development cycle, and specifically to directed-energy-deposition (DED) and powder bed fusion processes (PBF) processes. The appearance and geometry of the molten material, or the melt-pool, at the point of interaction between the energy source and material are popular features used for the prediction of defects or for geometry control. In-situ imaging is a popular and low-cost solution to observe the melt-pool, with image processing heuristics or ML feature extraction methods being used to extract melt-pool features, classify or predict defects.

As an example, for DED and PBF processes, process instability or sub-optimal camera settings are often neglected process quality metrics; however, such metrics should arguably be the first step in vision data processing and analytics. Smoke, spatter, or large melt-pool geometry deviations can result from sub-optimal process parameters such as, but not limited to, deposition trajectory, velocity, feed-stock delivery rate, and energy source power, while pixel saturation, obstructed field of view, or an out-of-focus lens are camera-related issues; such issues are often not considered, with most studies focusing on unrealistic laboratory-like conditions for observations. Sub-optimal process parameters and/or camera setup can lead to the occlusion of melt-pool features and the inability to use these images for further feature extraction, process control, or defect prediction.

Generally, the predictive performance of supervised ML models depends on the quality and size of the annotated training dataset. While data generation has become easier than ever with innovations in monitoring technologies, annotating unlabeled data can be labor-intensive, difficult and time-consuming. This is especially true in AM, where imaging-based process monitoring can generate high-dimensional data over long periods of time, which often requires manual annotation on the pixel level.

Active learning (AL) is a sub-field of ML focused on improving the performance of ML models by using the least amount of annotated training data. Instead of annotating and training a model on a subset of the available data selected through uniform random sampling (RND), AL trains a ML model in an iterative way. At each iteration, the ML model is re-trained on the existing and newly labeled data instances, which have been selected by a query strategy and manually annotated by humans. This process is repeated until termination, or when the desired number of labeled instances is achieved.

The goal of the query strategy is to select unlabeled instances which will lead to the highest performance gain of the ML model. Uncertainty sampling (US) is a popular strategy which selects instances based upon the predicted class uncertainty but can lead to the selection of redundant instances or outliers which do not add to the model performance. Although many efforts have been made to improve uncertainty sampling, they often introduce additional computational complexity. Furthermore, comparison shows that uncertainty sampling still ranks near to top among existing query strategies.

Therefore, there is provided a novel method and system for active learning using adaptive weighted uncertainty sampling (AWUS).

### SUMMARY

The disclosure is directed at a novel method and system for active learning using adaptive weighted uncertainty sampling (AWUS). In one embodiment, the disclosure is directed at an image-based classifier for additive manufacturing (AM) processes, such as, but not limited to, directed-energy-deposition (DED) or powder bed fusion processes (PBF) processes, that is able to detect whether an image can be used for further information retrieval on melt-pool geometry based upon the visibility and presence of the melt-pool in the image.

In another embodiment, the disclosure includes a query strategy based on AWUS. Combining the AWUS methodology with random exploration of the instance space prevents or reduces the likelihood of a selection of redundant instances. At each active learning (AL) iteration, a probability-mass-function (pmf) is defined, and sampled without replacement, to form a batch of unlabeled instances. The shape of the pmf is dependent on the change of the model predictions between AL iterations. Whenever the model does not change, it is expected to have explored the instance space enough such that it can focus on exploiting model knowledge. A large change, on the other hand, may represent a large parameter uncertainty in the model, and exploration should be the focus. In the disclosure, to achieve this, AWUS converges towards equal sampling probability, equivalent to random sampling (RND), for large model changes, while near equivalent models between AL iterations assign a very large probability to the most uncertain unlabeled instances; the latter case converges towards uncertainty sampling.

In another embodiment, or in combination with the AWUS methodology, the disclosure is directed at a novel feature extraction and classification method via machine learning (ML) for in-situ quality prediction of DED or PBF processes. In one specific embodiment, the classifier predicts, based on melt-pool visibility, whether an image or data, acquired through in-situ measurements, can be used for further quality assurance data evaluation; with such evaluation as out of scope. The in-situ vision data sets of the AM process are often used for training purposes of ML models; such datasets typically include redundant images, as the process is repetitive in nature. Therefore, the current disclosure is directed at the use of AL via the AWUS method to significantly reduce the required annotation workload for effectively training ML models.

The use of the AWUS methodology in the disclosure is general in nature and can be applied to any ML task using a model capable of providing instance uncertainty. The DED feature extraction and classification methods can be extrapolated to other AM processes such as PBF where vision data is deployed to observe the interaction between an energy source and material.

In an aspect of the disclosure, there is provided a method of active learning including obtaining a set of instances; processing the set of instances via an adaptive weighted uncertainty sampling (AWUS) methodology to assign weightings to unlabeled instances within the set of instances to generate weighted unlabeled instances; and determining which of the weighted unlabeled instances should be processed further based on the assigned weightings.

In another aspect, after processing the set of instances, the method includes annotating at least one of the weighted unlabeled instances. In a further aspect, the method includes processing the determined weighted unlabeled instances. In yet another aspect, the method includes transmitting information associated with processing the determined weighted unlabeled instances. In yet a further aspect, obtaining a set of instances includes receiving a set of images generated by a data generating system. In an aspect, processing the set of instances via an AWUS methodology includes selecting a set of unlabeled instances from the set of instances; and calculating an exponential value for each of the set of unlabeled instances.

In yet a further aspect, calculating an exponential value for each of the set of unlabeled instances includes calculating the exponential value based on a similarity metric. In yet another aspect, processing the set of unlabeled instances via an AWUS methodology further includes calculating a probability mass function (pmf) value for each of the set of unlabeled instances. In another aspect, the method includes training a machine learning model on the processed set of unlabeled instances. In yet another aspect, the method includes obtaining a further set of unlabeled instances based on the training of the machine-learning model on the weighted unlabeled instances.

In another aspect of the disclosure, there is provided a non-transient computer readable medium containing program instructions for causing a computer to perform the method of obtaining a set of instances; processing the set of instances via an adaptive weighted uncertainty sampling (AWUS) methodology to assign weightings to unlabeled instances within the set of instances to generate weighted unlabeled instances; and determining which of the weighted unlabeled instances should be processed further based on the assigned weightings.

### DESCRIPTION OF THE DRAWINGS

Embodiments of the present disclosure will now be described, by way of example only, with reference to the embedded Figures.

FIG. 1a is a schematic diagram of the system in its environment;

FIG. 1b is a schematic diagram of a memory component of the system;

FIG. 1c is a schematic diagram of another embodiment of the system;

FIG. 2a is a flowchart outlining a method of active learning using adaptive weighted uncertainty sampling (AWUS);

FIG. 2b is a schematic diagram and flowchart of one embodiment of system interactions;

FIG. 3 is a flowchart outlining a method of AWUS;

FIG. 4 is a schematic diagram showing one embodiment of training a directed energy deposition (DED) image classification model;

FIG. 5 is an example of a DED image;

FIG. 6 is an example of a DED dataset;

FIGS. 7a and 7b are graphs showing DED feature extraction and classification performance;

FIG. 8 is a set of images showing simulation results;

FIG. 9 is a graph showing active learning performance results of AWUS against other query strategies;

FIG. 10 is a schematic diagram of the iterative process of active learning and AWUS;

FIG. 11 is schematic diagram showing a different between active and passive learning;

FIG. 12 is an image depicting a manual annotation process and example of such;

FIG. 13a is a chart comparing the disclosure versus current methods;

FIG. 13b is a schematic diagram showing how AWUS is adaptive;

FIG. 13c is a schematic diagram showing a performance evaluation of the disclosure; and

FIG. 14 is a schematic diagram showing the relation between relationship model change and sampling probability in AWUS.

### DETAILED DESCRIPTION

The following description with reference to the accompanying drawings is provided to assist in understanding of example embodiments as defined by the claims and their equivalents. The following description includes various specific details to assist in that understanding, but these are to be regarded as merely examples. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings but are merely used to enable a clear and consistent understanding. Accordingly, it should be apparent to those skilled in the art that the following description of embodiments is provided for illustration purpose only and not for the purpose of limiting the disclosure as defined by the appended claims and their equivalents.

The disclosure is directed at a system and method of active learning (AL) via adaptive weighted uncertainty sampling (AWUS). The disclosure may be seen as a system and method for feature extraction and image quality classification that classifies image quality into multiple categories based on predetermined criteria, such as, but not limited to, a visibility of a melt pool for directed-energy-deposition (DED) and/or powder bed fusion (PBF) processes. In one embodiment, the disclosure may be directed or applied to the field of additive manufacturing (AM).

In another embodiment, a single or several unlabeled instances or pieces of data, which may be referred to as a batch, are selected such as by a query strategy, and added to an existing pool of labeled instances after being processed using AWUS. The batches may also include annotation by the system or by an individual. The updated labeled pool is then used to train or re-train the machine learning (ML) classification model to select the unlabeled instances leading to the highest gain in classification performance.

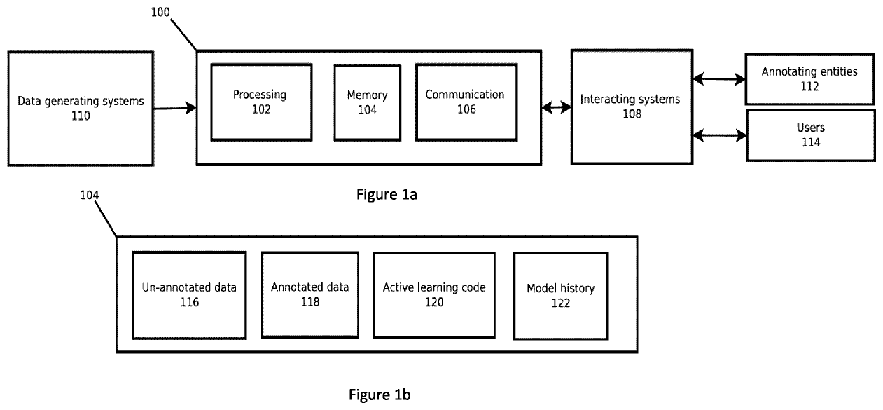

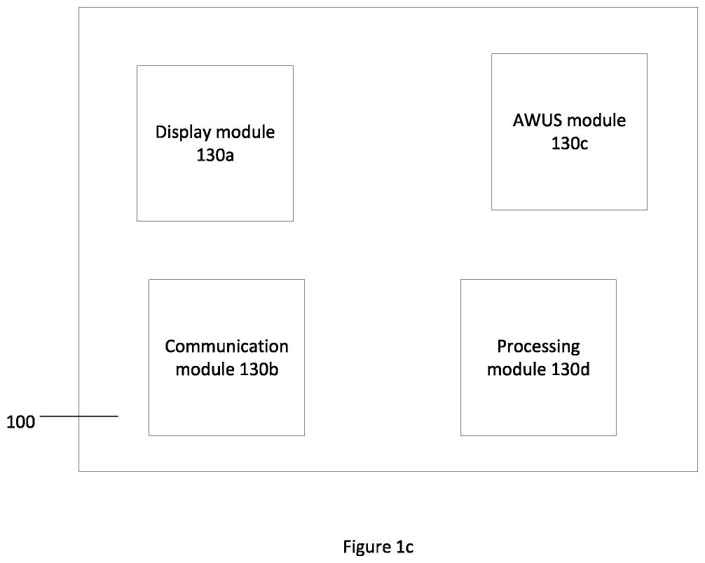

Turning to FIG. 1a, a schematic diagram of a system for active learning via AWUS in its environment is shown. System 100, which may be stored in a server or any computing system and the like, includes a memory component 104, a communication component 106 and a processing unit 102 that has access to, and or communicates with, the memory component 104.

The system 100 communicates with one or more data generating systems 110 to transmit and receive data which may then be stored in the memory component 104. In some embodiments, the data generating system 110 may be a camera that captures one or more images that is/are processed by the system 100.

Annotating entities 112 may interact with system 100 through interacting systems 108 by annotating un-annotated data selected by via a method of the disclosure. In this context, annotating entities 112 can be systems or human annotators able to generate annotations for un-annotated data. Interacting systems 108 encompass systems that allow users 114, which can be humanoid or systems, and/or annotating entities 112 to visualize, review, adapt or annotate results and/or data from the system or to input information into the system 100. In some embodiments, the users may be associated with a user computing device to review data processed by the system.

As schematically shown in FIG. 1b, the memory component 104 may store the data acquired from the one or more data generating systems 110 (such as in the form of un-annotated data 116 and annotated data 118), computer executable code 120 that, when executed on processing unit 102, may perform or implement a method of active learning and a history, or database, of trained machine learning models 122, preferably one for each iteration of active learning.

Turning to FIG. 1c, a schematic diagram of another embodiment of the system is shown. The system 100 may include a plurality of modules 130 that provide the functionality to perform, at least, the method of active learning via AWUS. The plurality of modules 130 may include a display module 130a that generates the images and displays that may be provided for a user to review results that are generated by the system 100. The display module 130a may also generate displays that show images that have been captured by the data generating devices to the user, such as via the user computer. The system 100 may further include a communication module 130b that enables communication of the system with the data generating system 110, the user computer or any other external computer peripherals, such as, but not limited to, a printer. The communication module 130b may also include hardware components to enable the communication via any known standard communication protocols. The system may further include an AWUS module 130c that performs an initial processing of images that are captured by the cameras such as to provide labels to unlabeled instances. Further detail with respect to other functionality provided by the AWUS module 130c is discussed below. The plurality of modules 130 may also include a processing module 130d that processes the images based on input from the AWUS module in order to determine if certain features within the images may be further processed to retrieve image information and the like.

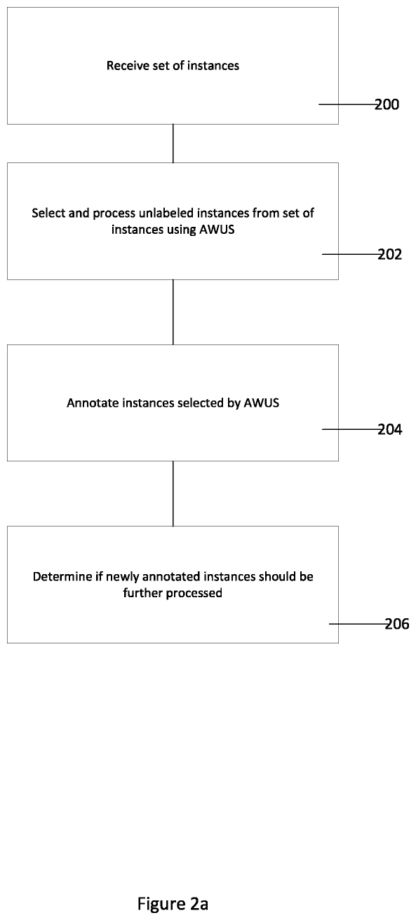

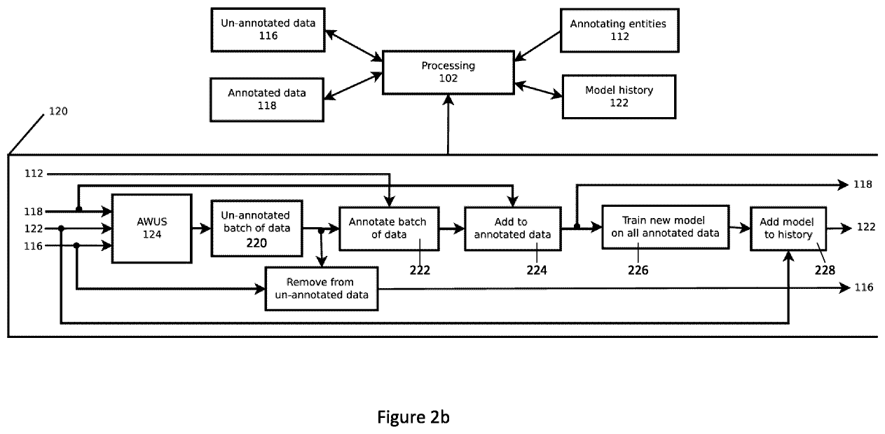

Turning to FIG. 2a, a flowchart outlining a method for active learning via AWUS is shown. In the current method, the method is based on a pool-based batch-mode active learning (PBAL) methodology where a large pool of unlabeled data instances are available prior to the performance of the method of the disclosure which finds benefit in the AM field. In the AM field, unlabeled instances in the form of in-situ acquired sensor data are often recorded during experiments, leading to pools of unlabeled data instances such as, but not limited to, frames from video recordings.

Prior to the initiation or execution of the method of the disclosure, it is assumed that there exists a set of instances (or a dataset) that have previously been labeled (seen as a set of labeled instances) or unlabeled that is stored in a database. The amount of classes per dataset is considered variable, therefore binary- and multi-class classification problems are considered.

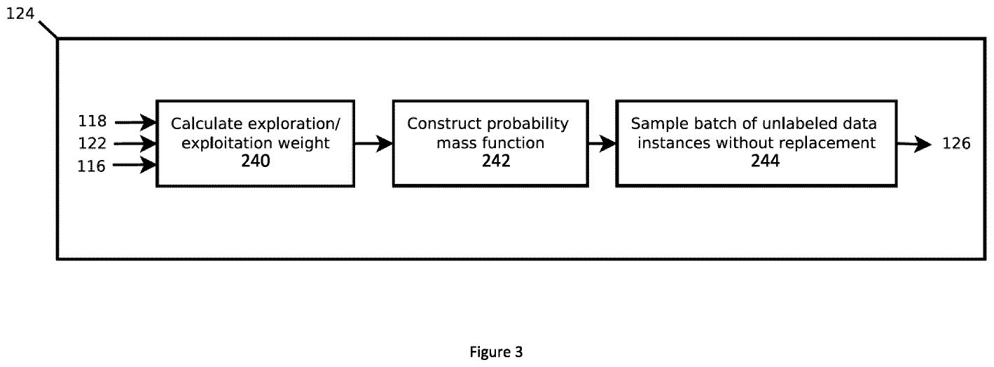

Initially, a set of instances are received by the system (200). The set of instances may include both labeled and unlabeled instances. Unlabeled instances are then selected from the set of instances and processed using AWUS (202). In some embodiments, a predetermined number (seen as a batch) of unlabeled instances are selected and processed or all of the unlabeled instances may be selected and processed. Processing the unlabeled instances with the AWUS technology assigns a weighting to each of the unlabeled instances. A flowchart outlining one method of AWUS is shown in FIG. 3. The method of the disclosure may be seen as being adaptive since it balances exploration and exploitation based upon the change of model predictions between AL iterations. In general, this change, in combination with the classification uncertainty of the unlabeled instances, assigns a weight to each unlabeled instance. These weights are turned into, or used to assist in the calculation of a probability-mass-function (pmf) which is sampled resulting in an unlabeled batch of instances being annotated.

After being processed via the AWUS methodology, the set of unlabeled instances may then be annotated (204), although this may or may not be necessary depending on the scenario. The instances may then be further processed or reviewed to determine if certain features within the images, or data, may be further processed (206) to retrieve image information, or for annotation, and the like. In another embodiment, this information may then be used in training ML models using a minimal or low number of annotated data.

Turning to FIG. 2b, a schematic diagram and flowchart of another embodiment of interaction between memory component 104, processing unit 102 and annotating entities 112 is shown. Each iteration of execution of a method of the disclosure updates the un-annotated data 116, annotated data 118 and the existing model history 122 through interaction with annotating entities 112 and the existing model history 122.

The un-annotated data 116, the annotated data 118 and the existing model history 122 are passed through an AWUS module 124 (or the AWUS module 130a).

In one embodiment of the method, the AWUS module selects a batch of un-annotated data from the un-annotated data 116 (200). The batch is then removed from the set of un-annotated data 116, annotated by annotating entities 112 (222) and added to the set of annotated data 118 (224). The updated annotated data 118 is then used to train a new predictive model (226) which is added to model history 122 (228). This single iteration of active learning may be repeated to obtain better or improved models. In this context, the selected batch of un-annotated data is a subset of the un-annotated data 116 and active learning code is based on a pool-based batch-mode active learning (PBAL) methodology where a large pool of unlabeled data instances is available a priori.

Turning to FIG. 3, a flowchart outlining a method of AWUS is shown. As discussed above, in one embodiment, inputs for performing the method of AWUS includes the un-annotated data 116, the annotated data 118 and the model history 122. In some embodiments, these may be stored in or seen as memory modules.

After receiving the inputs, a weight is assigned (240) to each un-annotated data instance in the batch of un-annotated data, which is turned into, or used to generate, a probability mass function (242). Iteratively, the batch of un-annotated data is sampled without replacement (244) from the probability mass function resulting in un-annotated batch from (220). The iteration termination conditions can be defined by any algorithm describing stopping conditions. Initially when model history 122 and/or annotated data 118 are empty, a batch of un-annotated data from (220) is selected using uniform random sampling.

The method of the disclosure may be seen as being adaptive since it balances exploration and exploitation based upon the change of model predictions between active learning (AL) iterations calculated from model history 122. To better understand this aspect of the disclosure, a definition for model change is provided, although any definition of model change can be used by for performing AWUS. In one embodiment of (240), for a conditional probability of a label y, given a data instance x and model m, trained on annotated data L is defined as P(y|x). A decision function d which predicts the class y for a given instance x, may be seen, or defined, as:

$$d ( x ) = {argmax}_{y ∈ C} P ( y \vert x )$$

The previous and current decision functions d and dare available at each AL iteration since the previous and current classification models m and n are available. In some embodiments, both decision functions may be used to predict the class labels of all data instances. The difference between the predictions, which is related to model change, can be quantified using any metric able to define similarity. While different metrics may be contemplated, in embodiments of the disclosure, the disclosure uses a cosine similarity metric and a ratio similarity metric. In one embodiment, when the metric is a cosine similarity metric, S_{c}, (seen as s in the equation below) similarity may be defined as:

$$s = \frac{〈 D , \overline{D} 〉}{‖ D ‖ ‖ \overline{D} ‖}$$

where D and D⁻ represent ordered sets of the real-valued previous and current class label predictions for all annotated data instances 118 and un-annotated data instances 116 with positive range 0<=s<=1.

In one embodiment, the similarity metric may be converted to an angular distance, α, where: α=cos⁻¹(s)/π which maps similarity values s:[0,1] to α:[0.5,0]. The angular distance may be used to balance the focus between exploration of the instance space and exploitation of the current model knowledge. The method of the disclosure then calculates an exponential weight e for each AL iteration (which is defined by the cosine, or other, similarity metric) to shape the pmf of each instance according to model change. In the embodiment with the cosine similarity metric, the exponential weight may be seen as e={(1/α)−2 when α>ε} and e={(1/ε)−2 otherwise} with ε approaching 0 or a very small number such that the divisor is not 0. In one specific embodiment, ε=1e−4. The exponential weight e inversely scales α such that α:[0.5,0] goes to e[0,(1/ε)−2)] and is used to weight the classification uncertainty of each unlabeled instance.

In another embodiment, when the metric is a ratio similarity metric, S, similarity may be defined as:

$${S}_{r} = N / \vert X \vert$$

where

$$N = {\sum }_{x ∈ X} {1}_{[ d ( x ) = d ( x ) ]}$$

which represents the number of equivalent predictions with 1 as the indicator function.

In other embodiments, in the descriptions below, the similarity metric S can refer to either the cosine similarity metric or the ratio similarity metric. The cosine and ratio similarity metric may be in a range of about 0≤s≤about 1 since d(x)∈Z⁺. As with the cosine similarity metric, for the ratio similarity metric, the method of the disclosure calculates an exponential weight, e, for each AL iteration as defined by the ratio similarity metric to shape the pmf of each instance according to model change. It is understood that this may also apply when the cosine similarity metric is used. The exponential weight may be seen as:

$$e = 1 / ( 1 - max {( S , ε )}^{- 1} )$$

where ε is a very small number such as, but not limited to, ε=0.0001, such that the divisor is not zero. As discussed above, the exponential weight e inversely scales and is used to weight the classification uncertainty of each unlabeled instance. Although multiple metrics exist to quantify classification uncertainty, in one embodiment, for simplicity or explanation, the method may use least confidence.

After calculating the exponential/exploitation value, the system may then calculate a pmf value for each of the instances (242). In one embodiment of (242), when the system uses least confidence, the instance uncertainty maybe defined as:

$$u ( x ) = 1 - {max}_{y ∈ C} \overline{P} ( y \vert x )$$

where P̅ represents the conditional probability of model m̅ and C represents the set of classes. Since the range

$$0 \leq u ( x ) \leq \frac{C \vert - 1}{C}$$

is dependent on the number of possible classes in the dataset, a normalized uncertainty n(x) is introduced where n(x) is defined as:

$$n ( x ) = \frac{\vert C \vert}{\vert C \vert - 1} u ( x )$$

with a range of about 0<=n(x)<=about 1. The exponential weight e and the normalized uncertainty n(x) are then used to assign a weight w(x) to each unlabeled instance x using the equation which represents the output of (242):

$$w ( x ) = {( n ( x ) 1 )}^{e}$$

where with range 1≤w(x)≤2 [symbol] ⁻²≈∞. The pmf, p(x), is then calculated in (244) using the weighting value using the equation:

$$p ( x ) = \frac{w ( x )}{W} ∀ x ∈ {U}_{N}$$

with Uₛ⊆U the subset of available unlabeled instances during batch construction. Normalizing constant

$$W = {\sum }_{x ∈ {U}_{s}} w ( x )$$

scales the weights W(x) such that

$${\sum }_{x ∈ {U}_{s}} p ( x ) = 1$$

and p(x) resembles a pmf.

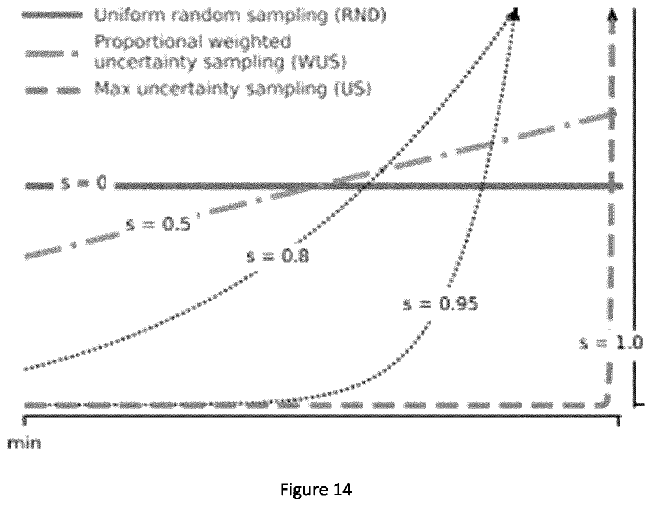

The relation between instance uncertainty u(x) and the probability of being sampled from p(x) as a function of s is shown in FIG. 14. The particular values s=0, 0.5, 1 result in exponents e=0, 1, ∞ leading to uniform random sampling (RND), proportionally weighted uncertainty sampling (WUS) and max uncertainty sampling (US) respectively.

In some embodiments, such as with the cosine similarity metric, an angular value a of zero corresponds to pure uncertainty sampling as the exponent e converges towards infinity. The sampling probability of the instance with the highest uncertainty will converge to 1 as all others converge to 0. Uniform random sampling occurs when α=0.5 as the exponent e=0. Any other value 0<α<0.5 acts as a trade-off between the two.

AWUS is applicable to any ML dataset or task, with the only constraint being a model capable of providing instance uncertainty. No definition of instance similarity for instance exploration is needed, AWUS is therefore well suited for AL tasks where instance similarity can be difficult to define, such as computer vision in AM, and DED particularly.

After determining the pmf for each instance, a batch of un-annotated data instances is selected. If the batch is full, the system transmits the batch of data instances to memory which can be accessed by active learning code to update the annotated data 118 and un-annotated data 116, train a new predictive model and add that model to model history 122.

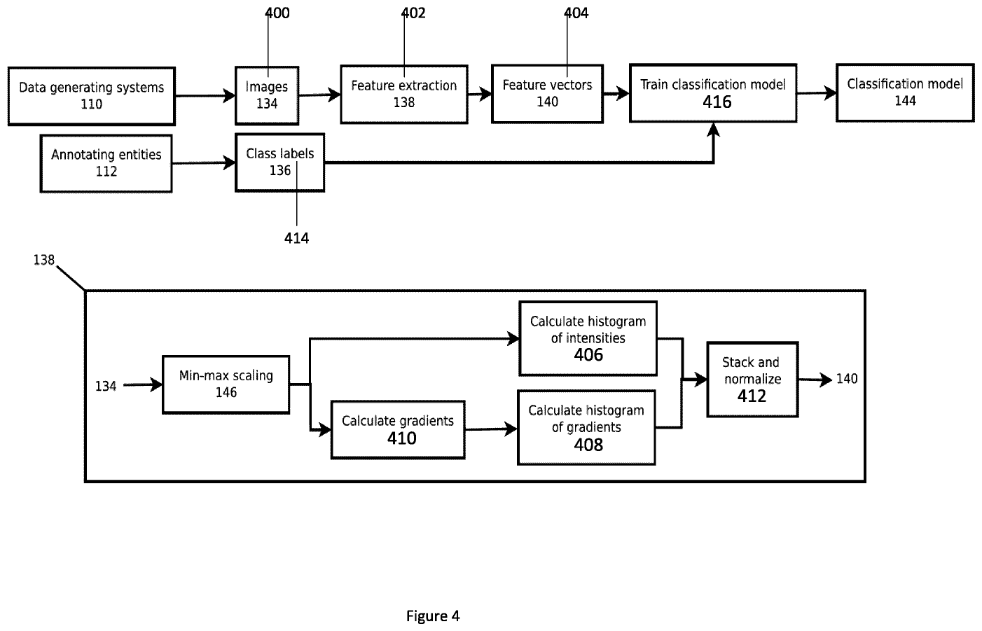

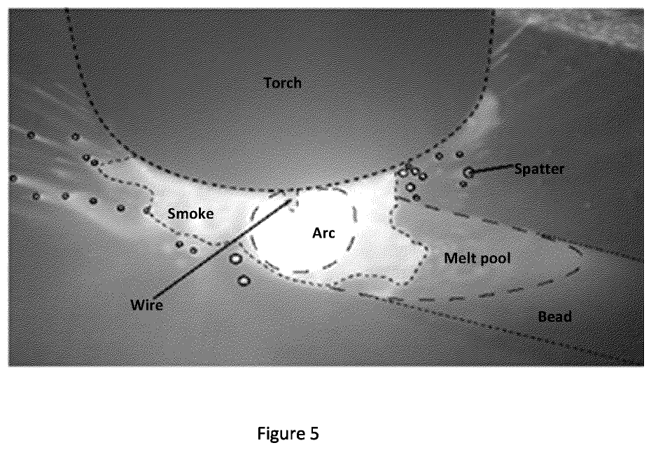

Turning to FIG. 4, a flowchart outlining one embodiment of training a directed energy deposition (DED) image classification model is shown. Initially, a set of images 134 is generated (400) by a data generating system 110 (such as a camera) via a single or multiple DED processes. Images 134 may be pre-processed for dynamic range adjustment, noise reduction, chromatic aberration, lens distortion, or for recurring features within the set of images. An example image of images 134 is shown in FIG. 5. As shown in FIG. 5, the image shows a torch, a wire, smoke that results from contact between torch and wire, an arc, spatter, a melt pool and a bead.

In some embodiments, the image processing may be performed by the computer or central processing unit (CPU) and, in other embodiments, it may be performed by a user. Therefore, the image processing may or may not form part of the method of DED data processing.

In some embodiments, the prediction of process quality from imaging data is dependent on the quality of acquired sensor data. Since melt-pool geometric features are used for the prediction of melting mode phenomena, defects, deposition geometry, melt depth, cooling and solidification rates, the ability to observe and measure the melt-pool geometric features is required. In an embodiment for a desired ML classifier, based on melt-pool visibility, every image is intended to be labelled or classified as either (i) no melt-pool, (ii) occluded melt-pool or (iii) segmentable melt-pool by annotating entities 112 based on the presence and visibility of features in the field-of-view of the camera. The DED definition of the three classes, along with reasons to assign an image to a specific class are shown in Table 1.

TABLE 1

| Classification | Reasons to Classify |
|---|---|
| No melt-pool | Melt-pool not visible (process did not start yet, |
| | has ended, is interrupted or obstructed) or |
| | outside camera field-of-view. |
| Occluded melt-pool | Melt-pool visible but boundary obstructed |
| | through spatter, smoke, arc, torch, bead, wire, |
| | pixel saturation, bad lens focus. |
| Segmentable melt-pool | Melt-pool visible and boundary not obstructed. |

Each image in the set of images 134 is thereafter compressed (402) using feature extraction module 138 to generate lower dimensional feature vectors 140 (404) to reduce computational complexity; to extract features related to visual signatures of the objects that are processed in; to reduce a sensitivity of the images to different lighting conditions and/or to ensure invariance of response to rotation and position the field-of-view (FOV). FIG. 4 also provides a more detailed via of the feature extraction module 138. In one embodiment, to reduce sensitivity to different lighting conditions, a min-max scaling component 146 within the feature extraction module 138 may be used on each image, I, where:

$$K = ( I - min ( I ) ) \cdot {( max ( I ) - min ( I ) )}^{- 1}$$

where K represents the scaled image such that max(K)=1 and min(K)=0.

Feature vectors 140 are thereafter constructed for each image. In one embodiment, this may be performed by concatenating, or calculating, a histogram of pixel intensities (406) and a histogram of pixel gradient magnitudes (408) where gradient images are created using (410). As understood, histograms provide information on the distribution of pixel values, therefore being invariant to rotation or position. Furthermore, the value of each histogram bin (or feature) may be determined by calculating the number of pixel values in a value range. This calculation enables each bin to be assigned a different value range. A smaller range of pixel values assigned to each bin requires more bins to capture the complete range of pixel values. This provides the ability to increase or reduce the histogram size, thereby controlling the number of features in each feature vector 140.

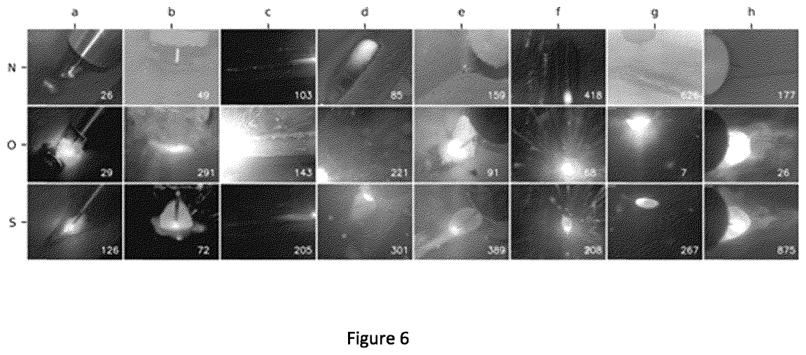

Each melt-pool class is expected to show, on average, a different image signature in terms of pixel intensities distribution. The distribution of pixel intensities in images N classified as “No melt-pool” is expected to be relatively uniform compared to the other classes due to the absence of higher intensity process signatures such as the plasma arc and spatter. The “Segmentable melt-pool” images S are expected to show larger differences in pixel intensities, since low intensity pixels belong to the background, while high intensity pixels belong to the melt-pool, arc, bead and other bright objects in the images. Occluding image signatures, such as smoke and spatter, are expected to be of equal or lower intensity compared to the plasma. Furthermore, these features tend to blend the images due to the smoothing effect of process, setup, and sensor phenomena. The distribution shape of pixel intensities for images O classified as “Occluded melt-pool” is therefore expected to show larger differences between the number of low and high intensity pixels than the “No melt-pool” class images but less than the “Segmentable melt-pool” images. Examples of N, O, S image classes are illustrated in FIG. 6.

To capture the intensity distribution of scaled general images named K, a histogram of intensities H_{K}=hist(K, b_{K}), is computed for every image (406) of FIG. 4 leading to a vector of b_{K} features (bins), with bin edges(0, b_{K}⁻¹, . . . , 1) Besides intensity information, the magnitude of gradients' distribution in each image, capturing edges, is used to further distinguish between the classes and calculated in (410) of FIG. 4. Images belonging to the “Segmentable melt-pool” class are generally sharp without the presence of many occluding features blending the images. Sharp edges at the melt-pool boundary are therefore preserved. This in contrast to the “Occluded melt-pool” images where the melt-pool boundary could be occluded by process, setup and/or sensor phenomena. The edge gradient intensities are therefore expected to be lower as well. The distribution of gradients in scaled images N belonging to the “No melt-pool” class will generally show a more uniform distribution of gradient intensities. The differences in distribution shape between the classes is therefore expected to be comparable to the distribution of pixel intensities. In one embodiment, the magnitude of gradients for each scaled image N is calculated using Sobel operators (410) as follows:

$${S}_{y} = {[ 10 - 1 ]}^{T} * ( [ 121 ] * K )$$

$${S}_{x} = {[ 121 ]}^{T} * ( [ 10 - 1 ] * K )$$

$$G = \sqrt{{S}_{x}^{2} {S}_{y}^{2}} / \sqrt{2}$$

with “*” the convolutional operator leading to image of gradient magnitudes G. In the current specific embodiment, the magnitude is divided by 2 to ensure max G≤1 and min G≥0. The resulting feature vector H=(H_{K}, H_{G}) is constructed by stacking of the histogram of normalized intensities H_{K} and histogram of magnitude of gradients H_{G}=hist(G, b_{G}) with bin edges (0, b_{G}⁻¹, . . . , 1), as is performed in (408).

In some embodiments, large differences in scale are possible with the use of histograms which may possibly lead to difficulties during classifier training. If this occurs, a normalized natural logarithm transformation may be applied to calculate an updated feature vector x. In one embodiment, this may be calculated using the equation:

$$x = ln ( H + 1 ) \cdot {( ln \sum H \cdot {2}^{- 1} + 1 )}^{- 1} - 0.5$$

such that max x<=0.5 and min x=>0.5. The resulting feature vector x is calculated for every image resulting in a set of feature vectors 140. Class labels are assigned (414) to each image in images 134 by annotating entities 112 resulting in a set of class labels 136. Class labels 136 and features vectors 140 are used to train (416) a classification model 144 which can be used for inference.

In experiments, a set of 36 experiment datasets were selected and constructed to evaluate the DED feature extraction and classification methodology and compare the AWUS active learning method and system of the disclosure against other query strategies such as RND (uniform random sampling), WUS (weighted uncertainty sampling), US (uncertainty sampling), EGA (Exponentiated Gradient Exploration), BEE (Balancing Exploration and Exploitation) and UDD (Uncertainty, Diversity and Density sampling) under different operating conditions. The datasets were a combination of ones available in Open-Source databases and created through feature extraction and annotation of eight in situ video recordings acquired from different DED processes. The eight DED datasets (a to h) are partially visualized in FIG. 6, where the number of images belonging to a specific class is provided in the right lower corner of the images.

Logistic Regression (LR), support vector machine (SVM), Gaussian naive bayes (GNB) and a Random Forest (RF) classifier are used for the active learning and DED classification performance experiments. For the RF, 10 decision trees were used and a linear kernel for the SVM. The F1-macro metric was used to evaluate classification performance. This metric can be interpreted as a weighted average of the precision and recall for each class and is intended to be more appropriate for multi-class classification problems.

With respect to DED feature extraction and classification results, to determine the influence of feature vector construction on classification performance, 1000 repeated experiments were performed for each classifier, DED dataset and intensity and gradient features combination. For each experiment, each annotated dataset was divided into a 50/50 training and validation set split using uniform random sampling. All images in both the training and validation set are thereafter turned into feature vectors of sizes 4, 8, 16, 32, 64, 128 and 256 for 3 feature balance cases; (i) 100% gradient features, such that the all features in the feature vector originate from the magnitudes of gradients histogram, (ii) 100% intensity features, such that only features from the histogram of intensities are used, or (iii) 50/50% gradient and intensity features, where equal size histograms are used such that b_{G}=b_{K}. Each classifier was thereafter trained and evaluated for every feature vector size and case.

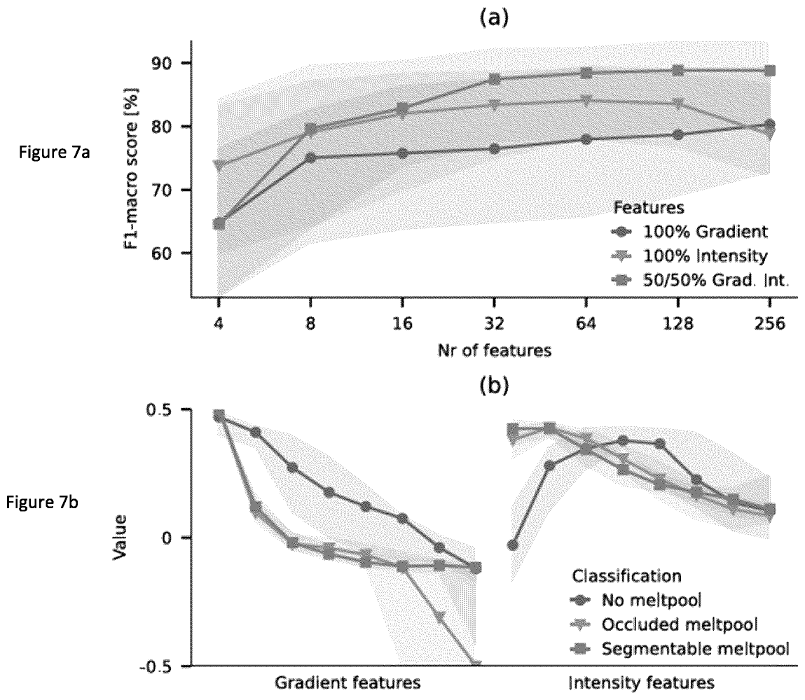

The F1-macro classification performance results over all classifiers and datasets are presented in FIGS. 7a and 7b. All transparent areas correspond to the 25 and 75 data percentiles, while solid lines are the medians. FIG. 7a shows a F1-macro score distribution over all classifiers combined on validation set against the number of features in each feature vector and FIG. 7b shows a distribution of 16-bin feature vector (50/50% grad. int) values for each class. The first 8 features of each feature vector hold gradient features and the last 8 hold intensity features. Although feature vectors including out of 100% intensity histogram features perform better than 100% gradient histogram features, the combination of both intensity and gradient features provides superior performance for an equal number of features. For feature vectors with more than four (4) features a 50/50% contribution of gradient and intensity features consistently out-performs the others, with a median F1-macro score of approximately 90%.

For all DED datasets, the 50/50% gradient and intensity 16-bin feature vector were selected for further analysis. This number of features was chosen as a trade-off between size and performance. Results showing use of the method of the disclosure with respect to distribution of the values of the features in all 16-bin feature vectors for each class is shown in FIG. 7b. The results confirmed that the different signatures in the lower, middle and higher intensity and gradient regions showed the expected differences between the classes. As such, the disclosure may be an effective tool in classifying DED images based upon the visibility of the melt-pool. In the experiments, the method of the disclosure was performed on an image-by-image bases without the need to normalize based on a global dataset mean and standard deviation. As a result, the disclosure method is easy to implement for real-time applications as a feature vector can be generated whenever the image is acquired from the sensor.

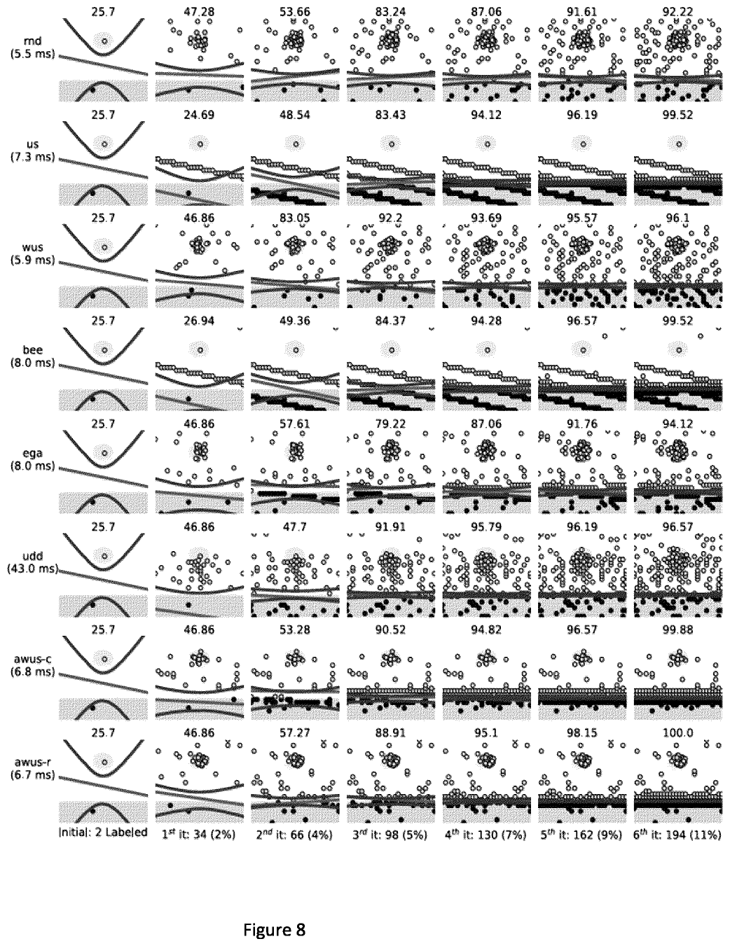

FIG. 8 provides an image of performance results of 10,000 AL simulations using the AWUS active learning method of the disclosure against the other sampling methods on a simulated “Horizon” dataset using a linear SVM classifier architecture. Different versions of the AWUS algorithm are compared against other query strategies, namely, RND (uniform random sampling), WUS (weighted uncertainty sampling), US (uncertainty sampling), EGA (Exponentiated Gradient Exploration), BEE (Balancing Exploration and Exploitation) and UDD (Uncertainty, Diversity and Density sampling)

One initial data instance is randomly selected and labeled for both classes (column 1). Thereafter, six AL iterations are performed (columns 2 to 7). The lowest F1-macro score of all simulations, at each iteration, is presented on top, and the average execution time on the left. Red lines provide the 95% decision boundary range over all simulations. Green lines show the decision boundary for a single AL simulation. White and black edge dots represent unlabeled and labeled instances of a single AL simulation. AWUS-R represents the AWUS method using a ratio similarity metric while AWUS-C uses the cosine similarity metric.

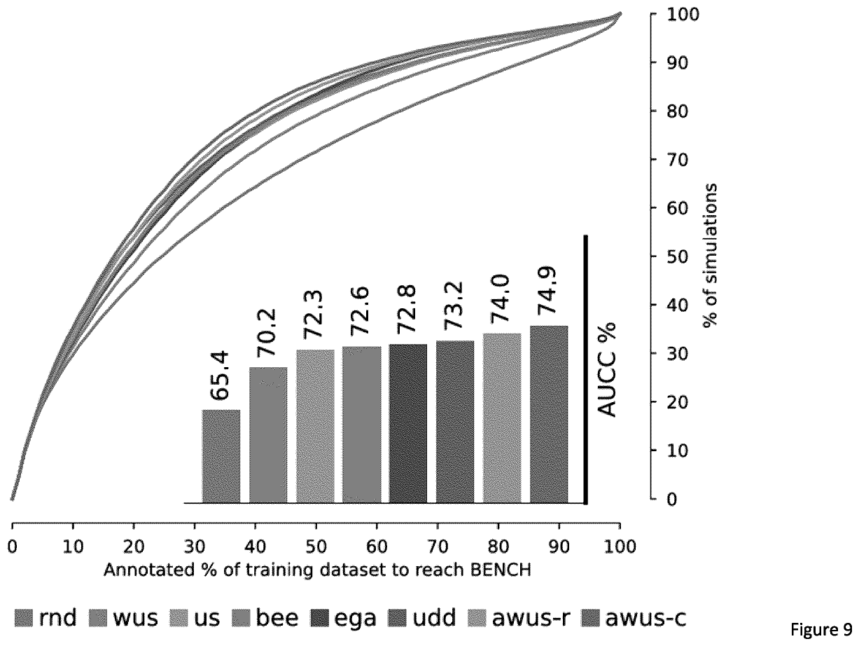

FIG. 9 provides active learning performance results of AWUS against all the other query strategies on the 28 real-world pre-annotated Open-Source and eight DED datasets. We continue by providing a high-level overview of the evaluation procedure. Each dataset is randomly split into a 50/50% training and validation set while maintaining the class balance ratio of the complete dataset in both sets. A single labeled instance per class from the training set is randomly selected and used as the initially annotated data. The un-annotated pool data holds all other data instances. To investigate the effect of batch size on the performance of each query strategy, active learning is performed for batch sizes 1, 4, 16 and 64. For each combination of batch size, classifier and query strategy active learning is performed on the same initial annotated and un-annotated datasets. Since many combinations of splitting the dataset into train and test sets exist, which might affect classification performance, we perform 1000 repeated active learning simulations, with different random selections of instances, on every dataset for all combinations of batch size, query strategy and classification model. Overall, AL results over 4 batch sizes, 4 classifiers and 36 datasets, repeated 1000 times per query strategy is displayed in FIG. 9. Each query strategy is sorted by their resulting AUCC (Area Under the Cumulative Curve) score. AWUS-C(cosine similarity) and AWUS-R (ratio similarity) are the winners overall, as they outperform all other query strategies, not only in AUCC value, but also by examining the cumulative curve as less annotations are needed compared to the others at every proportion of simulations.

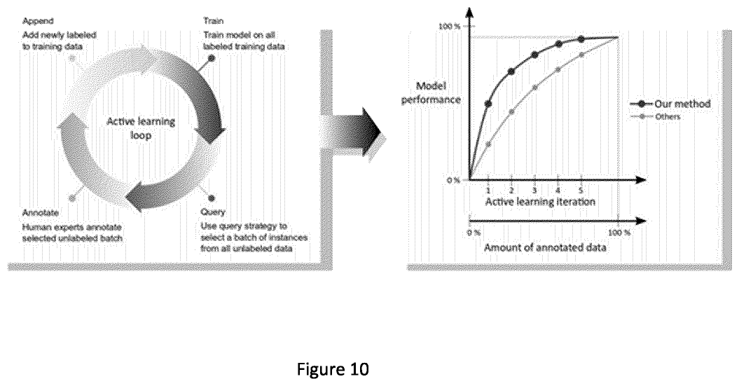

FIG. 10 shows another schematic of an embodiment of the active learning methodology and the results of the application of AWUS compared to other methods. In one embodiment, the disclosure may be seen as a system and/or method of performing semantic segmentation.

AWUS may be seen as a general active learning methodology meaning that it can be applied to any dataset with any data instance representation. This means, that AWUS is not limited to additive manufacturing (AM) processes only. Furthermore, AWUS has applications to, but is not limited to, the following more specific domains:
Machine learning related domains; Image segmentation, object detection, regression, clustering, anomaly detection, ranking, recommendation, forecasting, dimensionality reduction, reinforcement learning, semi-supervised learning, unsupervised learning, active batch selection methods for faster machine learning model training, adversarial learning, dual learning, distributed machine learning, transfer learning or any other machine learning related task.
Application domains; Medical imaging, Autonomous driving, Robotics, Natural language processing, Computer vision, Recommender systems, Video surveillance, Biomedical imaging, Human-in-the-loop systems, Transportation, Agriculture, Finance, Retail and customer services, Advertising, Manufacturing, or any other industry benefitting from a reduction in annotation load, reduction in model training time or requiring an annotation recommendation framework.

In the context of one embodiment of this disclosure, an energy source/material interaction process of interest is defined as any process involving an energy source and a molten metal material region of interest (ROI) on a substrate. Such processes include and are not limited to laser directed energy deposition additive manufacturing and welding processes. The disclosure of Adaptive Weighted Uncertainty Sampling (AWUS) may be seen as a general active learning method, applicable to any ML dataset or domain. For explanation purposes, the method was demonstrated for efficacy on a set of energy source/material interaction process of interest datasets, including welding and directed energy deposition (DED) additive manufacturing (AM). This method is NOT limited to such processes.

In one specific embodiment, the disclosure includes an AWUS component or module. Iteratively training a machine learning (ML) model using annotated data which has been selected for annotation by AWUS will drastically reduce the required number of annotations needed to reach a certain classification/model performance score. As discussed above, the data sampling method of the disclosure was validated on 28 open-source ML datasets from a variety of sources and 8 AM related datasets and outperforms random sampling and other state-of-the art query strategies using 4 different classifier architectures and batch sizes. AWUS is designed with scalability in mind. Large datasets, with high dimensional data, where instance similarity is difficult to define, such as image/video-based datasets. In specific, this method is well suited for AM (and energy source/material interaction processes of interest) due to the often large datasets created by in-process imaging data (IR, NIR, VIS) recordings. Therefore, AWUS can drastically reduce the number of annotations required for AM and, in general, for processes involving an energy source interacting on a material substrate. This can therefore highly reduce annotation time. A graphical abstract visualizing the iterative process of active learning and AWUS is presented in FIG. 10.

For another specific embodiment, the disclosure further includes a process quality classification and melt-pool segmentation machine learning method, tested on multiple processes involving an energy source and a molten region of interest (ROI) on a substrate. Such processes include and are not limited to laser directed energy deposition additive manufacturing and welding processes. This classification method can determine whether image quality is sufficient for further information extraction based on the visibility of the melt-pool. The segmentation model segments images containing a melt-pool, which are classified as being good quality, into background and foreground. The foreground pixels are intended to belong to the molten material/melt-pool.

The specific embodiment of the disclosure may also include enhanced machine learning tools for adaptive learning, methods and models to expand on the AWUS, the process quality classification and the melt-pool segmentation. These tools may be focused on data-efficient machine learning methods, with applications in additive manufacturing. The goal of these methods is to provide generalized or adaptive machine learning models able to perform well in new (unseen) environments. In the AM, setting this translates to new scenery, machines, processes or hardware setups.

For the AWUS, which may also be seen as an Active Learning query strategy framework, the AWUS may be applied to any dataset from any source in any feature representation format. In one embodiment, inputs to the AWUS may include an unlabeled dataset (videos from in-situ AM experiments for example); a ML model architecture able to quantify data instance uncertainties/probability; and additional AWUS operation parameters. Outputs from the AWUS may include at each AL iteration: a batch of instances from the large pool which should be annotated by experts (humans for example); and/or a predictive ML model (trained on all the annotated data so far) outperforming other query strategies with equal amount of annotated data at this point.

For the process/image quality prediction ML based classification model, in one embodiment, the machine learning-based classification model is designed for energy source/material interaction processes. The class definitions and subsequent annotations can be generalized and expanded to general imaging datasets (VIS/IR/NIR) from other processes, sceneries, or general applications. Inputs to the classification model may include images from in-situ machine vision at any angle, brightness, rotation, translation, scenery and/or machine.

Outputs from the classification model may include an image class which may include one of the following: No melt-pool (no melt-pool present, the process did not start yet or has already ended); Occluded melt-pool (low-quality/instable process/camera out of focus etc. leading to the inability to segment the melt-pool boundary from images); and/or Segmentable melt-pool (melt-pool boundary is visible and we are able to segment it).

In other embodiments, the AWUS, or active learning framework may be commercially packaged as a software tool. In other embodiments, the predictive machine learning models may be commercially packaged as a software tool or may be enhanced with additional optimizations using more data for training purposes.

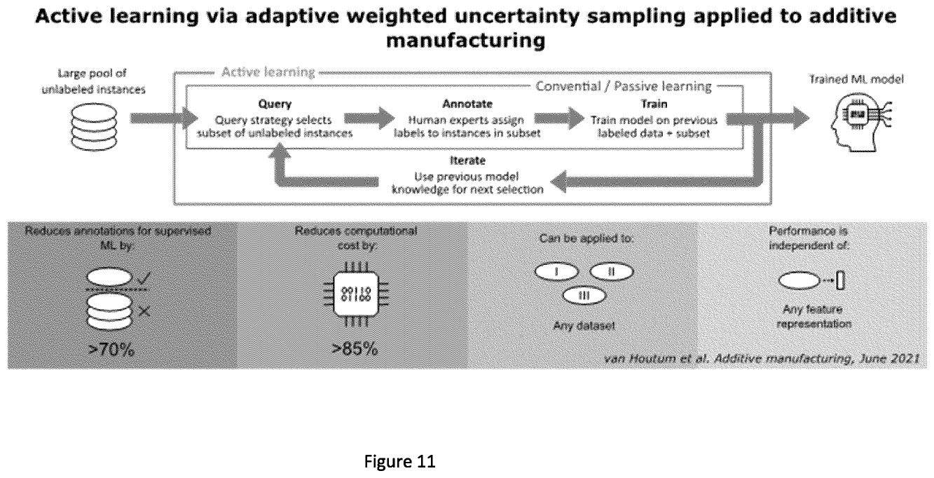

FIG. 11 shows a schematic diagram of the difference between active learning and passive learning. Passive learning typically has a single subset selection and does not exploit MODEL knowledge while active learning includes multiple subset selection iterations and exploits MODEL knowledge. Using Adaptive Weighted Uncertainty Sampling or AWUS, as the query strategy for active learning, the number of annotations and computational cost can be heavily reduced. Furthermore, it can be applied to any dataset or feature representation.

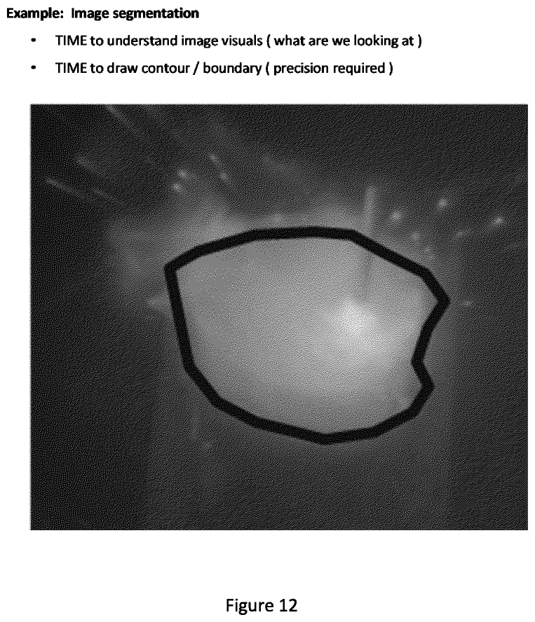

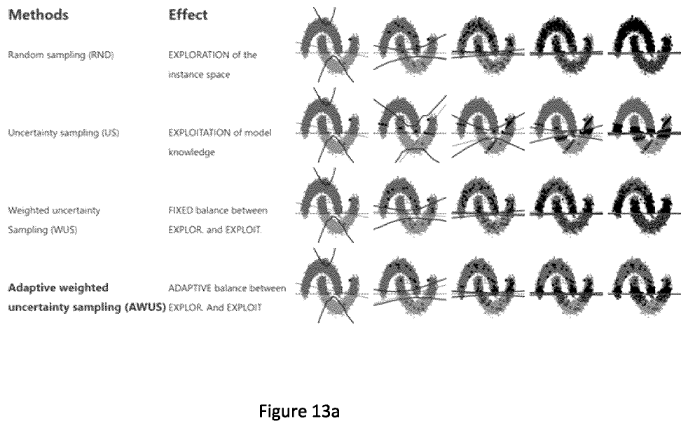

One of the problems with supervised ML is that it requires large amounts of annotated input and output data which may be time-consuming and difficult to obtain. However, by using active learning, the system and method of the disclosure may provide a high level of model performance using a least, or lower amount of annotated data. An example of annotation instance and complexity is schematically shown in FIG. 12. In one embodiment, the disclosure is directed at single-object segmentation where segmentation speed and memory usage may be improved.

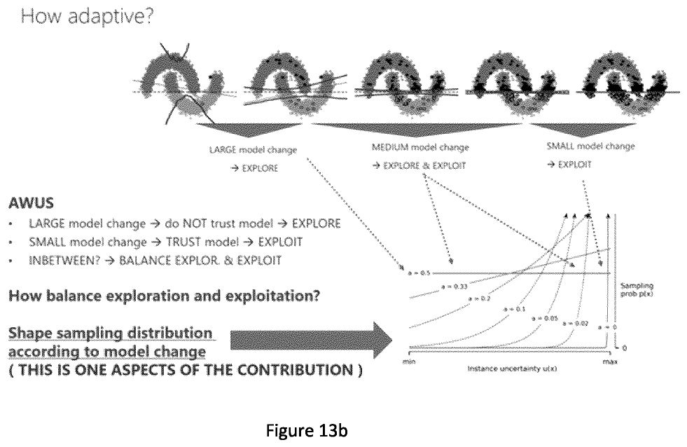

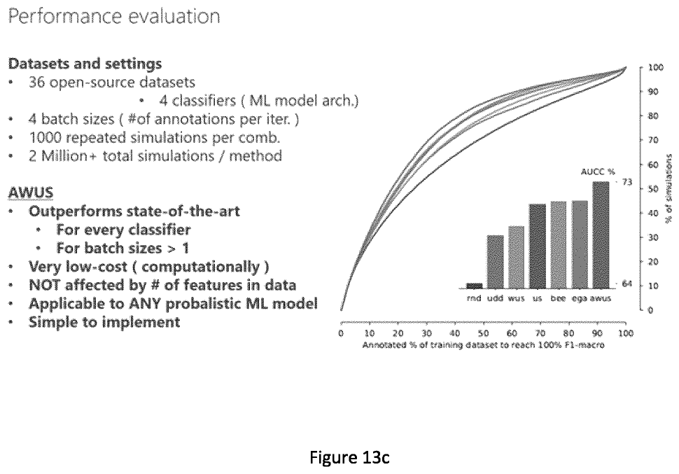

FIG. 13a provides a chart outlining problems with current active learning models in comparing with the AWUS methodology of the disclosure and FIG. 13b shows how AWUS is adaptive by balancing instance space exploration and model knowledge exploitation during the active learning process. FIG. 13c shows a performance evaluation of the system and method of the disclosure (AWUS).

It is understood that the system and method of the disclosure may find use or benefit in other applications outside of additive manufacturing, but that AM has been used in the current disclosure to provide an understanding of the innovation.

In other embodiments, while a cosine and/or ratio similarity methodology has been taught to quantify model change, the system and method of the disclosure may be implemented with any similarity metric able to describe model change.

Also, as discussed above, calculation of the exponential value, e, turns model change into an exponent through division and subtraction. While adjustment of exponent “e” is not described above, it may be performed to influence the probability mass function to focus more on random or uncertainty sampling for certain levels of similarity.

Also, for the algorithms or equations that relate to instance uncertainty using a “Least confidence” method, these equations may also be implemented or based on any methodology that can describe instance uncertainty.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding.

Embodiments of the disclosure or elements thereof may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the embodiments can also be stored on the machine-readable medium. The instructions stored on the machine-readable medium can be executed by a processor or other suitable processing device and can interface with circuitry to perform the described tasks. The above-described embodiments are intended to be examples only. Alterations, modifications and variations can be affected to the particular embodiments by those of skill in the art without departing from the scope, which is defined solely by the claims appended hereto.

What is claimed is:

1. A method of active learning comprising;
obtaining a set of instances;
processing the set of instances via an adaptive weighted uncertainty sampling (AWUS) methodology to assign weightings to unlabeled instances within the set of instances to generate weighted unlabeled instances; and
determining which of the weighted unlabeled instances should be processed further based on the assigned weightings.

2. The method of active learning of claim 1 further comprising, after processing the set of instances:
annotating at least one of the weighted unlabeled instances.

3. The method of active learning of claim 1 further comprising:
processing the determined weighted unlabeled instances.

4. The method of active learning of claim 3 further comprising:
transmitting information associated with processing the determined weighted unlabeled instances.

5. The method of active learning of claim 1 wherein obtaining a set of instances comprises:
receiving a set of images generated by a data generating system.

6. The method of active learning of claim 1 wherein processing the set of instances via an AWUS methodology comprises:
selecting a set of unlabeled instances from the set of instances; and
calculating an exponential value for each of the set of unlabeled instances.

7. The method of active learning of claim 6 wherein calculating an exponential value for each of the set of unlabeled instances comprising:
calculating the exponential value based on a similarity metric.

8. The method of active learning of claim 6 wherein processing the set of unlabeled instances via an AWUS methodology further comprises:
calculating a probability mass function (pmf) value for each of the set of unlabeled instances.

9. The method of active learning of claim 1 further comprising training a machine learning model on the processed set of unlabeled instances.

10. The method of active learning of claim 9 further comprising:
obtaining a further set of unlabeled instances based on the training of the machine learning model on the weighted unlabeled instances.

11. A non-transient computer readable medium containing program instructions for causing a computer to perform the method of:
obtaining a set of instances;
processing the set of instances via an adaptive weighted uncertainty sampling (AWUS) methodology to assign weightings to unlabeled instances within the set of instances to generate weighted unlabeled instances; and
determining which of the weighted unlabeled instances should be processed further based on the assigned weightings.
